(19) United States
(12) Patent Application Publication
(10) Pub. No.: US 2026/0293954 A1
(43) Pub. Date: Oct. 1, 2026

(54) UNSUBSTITUTED MODIFIED STARCH AND METHODS FOR MAKING THE SAME

(71) Applicant: Cargill, Incorporated, Wayzata, MN (US)

(72) Inventors: Kimberly Jean HALEY, Maple Grove, MN (US); Violetta Ewa SCHUBE, Tostedt (DE); Varatharajan VAMADEVAN, Plymouth, MN (US)

(73) Assignee: Cargill, Incorporated, Wayzata, MN (US)

(21) Appl. No.: 19/469,135

(22) PCT Filed: Mar. 27, 2024
(86) PCT No.: PCT/US2024/021595

§ 371 Date: Sep. 25, 2025

Related U.S. Application Data
(60) Provisional application No. 63/492,269, filed on Mar. 27, 2023.

(51) Int. Cl. A23L 29/219; A23C 9/137; A23C 9/154; A23L 19/00; A23L 23/00; C08B 31/00

(52) U.S. Cl. CPC A23L 29/219; A23C 9/137; A23C 9/1544; A23L 19/09; A23L 23/00; C08B 31/003

(57) ABSTRACT

An unsubstituted, crosslinked starch has a hot paste viscosity in a range of 100 cP to 1500 cP at pH 3 and 5.5 wt-% solids, a retrogradation enthalpy of 2.3 J/g or less at 1 week and 7 J/g or less at 4 weeks, and conclusion temperature of retrogradation of less than 75° C. The starch may be prepared from waxy tapioca, waxy rice, waxy-sugary-2 corn mutant, short chain waxy potato, waxy wheat, high phosphorylated waxy starch, or a combination of any two or more thereof. The starch may be crosslinked. The starch may be used in food products, nutritional products, pharmaceutical products, personal care products, paper products, and the like. A method of making the starch includes mixing a native starch with water to form a slurry; adjusting pH of the slurry to alkaline; and mixing a crosslinking agent with the slurry to effect a crosslinking reaction.

### CROSS-REFERENCE TO RELATED APPLICATIONS

This application claims the benefit of U.S. Provisional Application No. 63/492,269, filed Mar. 27, 2023, which is incorporated by reference herein in its entirety.

### TECHNICAL FIELD

The present disclosure relates to modified starches. In particular, the present disclosure relates to unsubstituted crosslinked waxy starches and to methods of making such modified starches.

### BACKGROUND

Starch, in general, contains two types of polymers: amylose which is essentially linear and amylopectin which is branched. Starches low in amylose are often referred to as “waxy” starches. Exemplary sources of waxy starches include waxy tapioca, waxy rice, waxy-sugary-2 corn mutant, short chain waxy potato, waxy wheat, high phosphorylated waxy starch, and the like. In nature, root and tuber starches have generally higher amounts (varying from 50-980 ppm) of phosphate monoesters covalently bound to starch. Cereal starches like maize, rice, wheat, on the other hand, generally have lower amounts of phosphate monoesters (typically ranging from 0-80 ppm). The phosphorylation of starch which is catalyzed by a protein with the activity of a glucan, water dikinase (GWD), or phosphor-glucan, water dikinase (PWD) gives rise to additional phosphate monoester bonds in glucan chains. Covalently bound phosphate monoesters could be enhanced by selective breeding programs or by transgenic approach.

Starch may be used to thicken (e.g., viscosify) foods and other products, such as cosmetics and pharmaceutical products. Starches from different sources vary in texture, taste and viscosifying properties. Native starches may be modified to better control the properties provided by the starch and to improve the stability of the starch. Such properties include, for example, viscosity, texture (smoothness, non-cohesiveness), process stability, cold storage stability, and the like. Typically, substitution with various alkyls or hydroxyalkyls, such as acetyl or hydroxypropyl, has been used to provide cold storage stability and increased viscosity. Crosslinking has been used to control process stability and to maintain viscosity.

Improvements to modified starches and to methods of making them are desired.

### SUMMARY

Modified starches and, in particular, unsubstituted crosslinked waxy starches are provided. In one aspect, the present technology provides an unsubstituted crosslinked starch having a hot past viscosity in a range of 100 cP to 1500 cP (measured at pH 3 and 5.5 wt-% solids), and a retrogradation enthalpy measured at 1 week of storage at 4° C. and a gelatinization enthalpy, wherein the retrogradation enthalpy is about 25% or less, 20% or less, 15% or less, 10% or less, or 5% or less of the gelatinization enthalpy. The unsubstituted crosslinked starch may have a retrogradation enthalpy measured at 1 week of storage at 4° C. of 2.3 J/g or less. The unsubstituted crosslinked starch may have a retrogradation enthalpy measured at 4 weeks of storage at 4° C. that is 50% or less of the gelatinization enthalpy.

In one aspect, the present technology provides an unsubstituted crosslinked starch that may have a hot paste viscosity in a range of about 100 cP to about 1500 cP measured at pH 3 and 5.5 wt-% solids. The unsubstituted crosslinked starch may have a retrogradation enthalpy of 3 J/g or less at 1 week and 7 J/g or less at 4 weeks, and a conclusion temperature of retrogradation of less than 75° C. The unsubstituted crosslinked starch may have a hot paste viscosity in a range of about 300 cP to about 1300 cP, about 400 cP to about 1200 cP, about 500 cP to about 1200 cP, about 600 cP to about 1200 cP, about 600 cP to about 1000 cP, about 400 cP to about 900 cP, or about 600 cP to about 900 cP. The unsubstituted crosslinked starch may have a retrogradation enthalpy of about 2.8 J/g or less, about 2.5 J/g or less, about 2.4 J/g or less, about 2.3 J/g or less, about 2.2 J/g or less, about 2.1 J/g or less, or about 2.0 J/g or less, measured at 1 week of refrigerated storage. The unsubstituted crosslinked starch may have a retrogradation enthalpy of about 0.7 J/g or greater, about 0.8 J/g or greater, about 0.9 J/g or greater, or about 1.0 J/g or greater, measured at 1 week of refrigerated storage. At 4 weeks of refrigerated storage, the unsubstituted crosslinked starch may have a retrogradation enthalpy of about 7 J/g or less, about 6.7 J/g or less, about 6.5 J/g or less, about 6.3 J/g or less, about 6.2 J/g or less, 6.1 J/g or less, or about 6.0 J/g or less.

The unsubstituted, crosslinked starch may be prepared from any waxy starch source, including waxy tapioca, waxy rice, waxy-sugary-2 corn mutant, short chain waxy potato, waxy wheat, high phosphorylated waxy starch, or a combination of any two or more thereof. The unsubstituted, crosslinked starch may be crosslinked. In some aspects, the unsubstituted, crosslinked starch may include or may have unsubstituted, crosslinked waxy tapioca starch. The unsubstituted, crosslinked starch may be crosslinked using any suitable crosslinking agent such as sodium trimetaphosphate, phosphorus oxychloride, adipate, epichlorohydrin, citric acid or a combination of any two or more thereof.

The unsubstituted, crosslinked starch may include about 5 wt-% or less of amylose. In some aspects, the unsubstituted, crosslinked starch may be free, or substantially free, of amylose.

The unsubstituted, crosslinked starch may be prepared from a cassava plant, including, but not limited to, a cassava plant modified using CRISPER/Cas 9 technology. Additionally or alternatively, in any aspect herein, the unsubstituted, crosslinked starch may be prepared from a naturally occurring waxy cassava plant or a waxy cassava plant developed by non-genetic modification or conventional breeding.

According to some aspects of the present technology, the unsubstituted, crosslinked starch is not hydroxypropylated or acetylated.

According to some aspects of the present technology, the unsubstituted, crosslinked starch may be granular (not pre-gelatinized).

The unsubstituted, crosslinked starch may be stable through 2 or more, 3 or more, 4 or more, 5 or more, 6 or more, 8 or more, or 10 or more freeze-thaw cycles. According to some aspects of the present technology, the unsubstituted, crosslinked starch is stable through 4 or more freeze-thaw cycles.

In another aspect, the present technology provides a pre-gelatinized non-granular or partially gelatinized or agglomerated starch prepared using the unsubstituted, crosslinked starch described herein. In another aspect, the present technology provides food products including the unsubstituted, crosslinked starch are provided. The food product may be a dairy product. The dairy product may be or may include yogurt, sour cream, a fruit preparation, a dairy-based dessert, a pudding, or a combination of any two or more thereof. The food product may be a non-dairy yogurt or non-dairy pudding. The food product may be a sauce, a gravy, a dressing, a dip, a spread, a bakery filling, or a dry mix. The food product may be a pet food, a retort food, or a canned pet food.

The food product may include the unsubstituted, crosslinked starch at a rate of about 1 wt-% or greater, about 2 wt-% or greater, about 5 wt-% or greater, about 7.5 wt-% or greater, about 10 wt-% or greater, about 12.5 wt-% or greater, about 15 wt-% or greater, or about 20 wt-% or greater based on the total weight of the food product. The unsubstituted, crosslinked starch may be included at about 35 wt-% or less, about 30 wt-% or less, about 25 wt-% or less, about 20 wt-% or less, about 15 wt-% or less, or about 10 wt-% or less based on the total weight of the food product. In some aspects, the unsubstituted, crosslinked starch makes up from about 1 wt-% to about 35 wt-% or about 5 wt-% to about 25 wt-% of the food product.

In another aspect, the present technology provides methods of making the unsubstituted, crosslinked starch as described herein in any aspect. The method may include mixing a native starch with water to form a slurry; adjusting the pH of the slurry to an alkaline pH; and mixing a crosslinking agent with the slurry to effect a crosslinking reaction. The resulting unsubstituted, crosslinked starch exhibits hot paste viscosity in a range of about 100 cP to about 1500 cP (measured at pH 3 and 5.5 wt-% solids) and a retrogradation enthalpy measured at 1 week of storage at 4° C. and a gelatinization enthalpy, wherein the retrogradation enthalpy is about 25% or less, 20% or less, 15% or less, 10% or less, or 5% or less of the gelatinization enthalpy.

The resulting unsubstituted, crosslinked starch may exhibit a retrogradation enthalpy of about 2.3 J/g or less at 1 week and about 7 J/g or less at 4 weeks, and conclusion temperature of retrogradation of less than about 75° C.

The slurry may include from about 20 wt-% to about 45 wt-% of native starch dry solids. The pH of the slurry may be adjusted to a range of about 10 to about 13. The crosslinking reaction may be conducted at a reaction temperature of about 24° C. to about 45° C. and have a duration of about 0.5 h to about 10 h.

The crosslinking agent added to the slurry may include sodium trimetaphosphate, phosphorus oxychloride, adipate, epichlorohydrin, or a combination of any two or more thereof. The method may further include mixing a salt into the slurry. The slurry may include from 0.5 wt-% to 10 wt-% of salt.

The method may further include adjusting the pH after crosslinking to a range of 5 to 6.

The method may further include dewatering and drying the starch.

The native starch may include waxy tapioca, waxy rice, waxy-sugary-2 corn mutant, short chain waxy potato, waxy wheat, high phosphorylated waxy starch, or a combination of any two or more thereof. The native starch may include 5 wt-% or less of amylose. In some aspects, the native starch is free or substantially free of amylose.

According to some aspects of the present technology, the native starch may include waxy tapioca starch and the unsubstituted, crosslinked starch comprises unsubstituted crosslinked waxy tapioca starch.

The unsubstituted, crosslinked starch may exhibit a hot paste viscosity is in a range of 400 cP to 1300 cP.

The method may be free of hydroxypropylation or acetylation.

### BRIEF DESCRIPTION OF THE DRAWINGS

FIG. 1A is a graphical presentation of RVA viscosity profiles (pH 3 buffer/5.5% DS) of the POCl₃ crosslinked samples of Example 1.

FIG. 1B is a graphical presentation of RVA viscosity profiles (pH 6.5 buffer/5.5% DS) of the POCl₃ crosslinked samples of Example 1.

FIG. 1C is a graphical presentation of RVA viscosity profiles (pH 3 buffer/5.5% DS) of the STMP crosslinked samples of Example 1.

FIG. 1D is a graphical presentation of RVA viscosity profiles (pH 6.5 buffer/5.5% DS) of the STMP crosslinked samples of Example 1.

FIG. 1E is a graphical presentation of DSC retrogradation enthalpy results of the samples of Example 1.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

The term “tapioca starch” is used here to refer to starch obtained from the roots of the cassava plant (Manihot esculenta).

The term “waxy starch” is used here to refer to starch that is low in amylose, such as starch including 5 wt-% or less, 3 wt-% or less, 2 wt-% or less, or no (i.e., free of) amylose.

The term “gelatinization” is used here to refer to a phase transition of starch upon heating in excess water, when semi-crystalline starch granules undergo a change of state from an ordered to a disordered structure.

The term “retrogradation” refers to the re-association of disordered glucan chains of gelatinized starch via hydrogen linkages into an ordered structure. Throughout the realignment process, the reduction in intermolecular distance between glucan chains leads to the removal of water from gel, a phenomenon known as “syneresis.” Starch retrogradation, including retrogradation enthalpy and melting transition temperatures, can be characterized using differential scanning calorimetry (DSC). Retrogradation enthalpy reflects the melting of crystallites or uncoiling of amylopectin double-helices of retrograded starch. The melting transition temperatures are described as the onset temperature (To) and conclusion temperature (Tc). Melting temperature range reflects the temperature between onset melting of crystallites and conclusion temperature. The conclusion temperature Tc may be referred to as retrogradation conclusion temperature or conclusion temperature of retrogradation. Measurement of retrogradation enthalpy, To, and Tc are further discussed in Vamadevan and Bertoft, Impact of Different Structural Types of Amylopectin on Retrogradation, Food Hydrocolloids 80 (2018) 88.

The term gelatinization enthalpy is used to refer to melting of starch crystallites (loss of double helical order or rupture of H-bonds between glucan strands). Differential scanning calorimetry (DSC) is widely used to detect the phase transition. DSC measures gelatinization transition temperatures (onset [To], peak [Tp], and conclusion [Tc]), and the enthalpy (ΔH) of gelatinization. The enthalpy of gelatinization (ΔH) is estimated by integrating the area between the thermogram and a base line under the peak and was expressed as J/g of dry starch. Gelatinization enthalpy refers to the amount of energy required to gelatinize the starch, i.e., melt the crystalline structure of starch (order to disordered state). Gelatinization enthalpy and its measurement is further discussed in Vamadevan et al., On the Importance of Organization of Glucan Chains on Thermal Properties of Starch, Carbohydrate Polymers 92 (2013) 1653.

The terms “stable” and “stability” are used generally to refer to the ability to maintain structure, texture, and/or viscosity. In the context of starch, the terms “stable” and “stability” may be used to refer to various aspects of stability, including process stability under elevated heat and shear (shear conditions) and cold storage stability. Chemically crosslinked starches provide a desirable smooth texture and possess viscosity stability throughout the processing operation. Lack of process stability may be inferred from loss of viscosity during processing (e.g., under acidic or high shear conditions), as well as development of poor texture. Process stability may include resistance to process conditions such as heat, acid, shear stress, and the like. Cold storage stability may include both stability at refrigeration temperature and freeze-thaw stability (stability during freeze-thaw cycles). Cold storage stability at refrigeration temperature may be determined by measuring the retrogradation enthalpy of a starch after storage (e.g., 1 week or 4 weeks) at refrigeration temperature. A lower retrogradation enthalpy indicates improved cold storage stability at refrigeration temperature. Freeze-thaw stability may be determined by exposing the starch to a number of freeze-thaw cycles and observing changes (e.g., water separation) in the starch. A higher number of cycles without changes indicates improved freeze-thaw stability.

The term “refrigeration temperature” is used here to refer to a temperature range of about 2° C. to about 6° C. typically used in refrigerators. When used in the context of stability testing, the term “refrigeration temperature” is used to mean about 4° C.

The term “viscosifying starch” is used to refer to a starch capable of imparting increased viscosity.

The term “high phosphorylated” is used here to refer to plant varieties that include at least 10% more, at least 20% more, or at least 30% more of phosphate monoesters than traditional varieties. Traditional varieties of plants include phosphate monoesters produced naturally during starch metabolism in the plant without selective breeding or over-expressing the GWD by a transgenic approach.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “alkylated” is used in this disclosure to describe compounds that are reacted to replace a hydrogen atom or a negative charge of the compound with an alkyl group, such that the alkyl group is covalently bonded to the compound.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In any aspect herein, the alkyl groups contain 1 to 20 carbon atoms, 1 to 10 carbon atoms, 1 to 6 carbon atoms, 1 to 4 carbon atoms, or 1 to 3 carbon atoms. Generally, an alkyl group is attached to the rest of the molecule by a single bond, for example, the alkyl groups may include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc. In some aspects, the alkyl group is optionally substituted by one or more of the following substituents: halo, cyano, nitro, oxo, thioxo, —OR^{a}, —SR^{a}, —OC(O)—R^{b}, —N(R^{a})₂, —C(O)OR^{a}, —C(O)N(R^{a})2 —N(R^{a})C(O)OR^{a}, —N(R^{a})C(O)R^{a}, N(R^{a})S(O)₂ R^{b}, —S(O)₂O R^{a} and —S(O)₂N(R^{a})₂, where each R^{a} is independently hydrogen, alkyl, fluoroalkyl, cycloalkyl, aryl, heterocyclyl, or heteroaryl and each R^{b} is independently hydrogen, alkyl, fluoroalkyl, cycloalkyl, aryl, heterocyclyl, or heteroaryl.

The term “substantially” as used here has the same meaning as “significantly,” and can be understood to modify the term that follows by at least about 95%, at least about 98%, at least about 99%, or at least about 99.5%. The term “substantially free” of a particular compound means that the compositions of the present disclosure contain less than 0.1% of the recited compound.

The term “not substantially” as used here has the same meaning as “not significantly,” and can be understood to have the inverse meaning of “substantially,” i.e., modifying the term that follows by not more than 10%, not more than 5%, or not more than 2%.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Any publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” or “such as,” are meant to introduce examples that further clarify more general subject matter. Unless otherwise specified, these examples are provided only as an aid for understanding the applications illustrated in the present disclosure, and are not meant to be limiting in any fashion.

In the methods described herein, the acts can be carried out in a specific order as recited herein. Alternatively, in any aspect(s) disclosed herein, specific acts may be carried out in any order without departing from the principles of the disclosure, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” is used here in conjunction with numeric values to include normal variations in measurements as expected by persons skilled in the art and is understood to have the same meaning as “approximately” and to cover a typical margin of error, such as ±10%, ±5%, or ±1% of a stated value or of a stated limit of a range and includes the exact stated value or range.

Terms such as “a,” “an,” and “the” and similar referents are not intended to refer to only a singular entity but include the general class of which a specific example may be used for illustration. It is understood that any term used in the singular may include its plural counterpart and vice versa, unless otherwise indicated herein or clearly contradicted by context.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range and refers to ranges which can be subsequently broken down into subranges as discussed above. Finally, as will be understood by one skilled in the art, a range includes each individual member.

As used herein, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like. The phrase “consisting of” excludes any element not specified.

The words “preferred” and “preferably” refer to aspects of the present technology that may afford certain benefits, under certain circumstances. However, other aspects may also be preferred, under the same or other circumstances. Furthermore, the recitation of one or more preferred aspects does not imply that other aspects are not useful and is not intended to exclude other aspects from the scope of the disclosure, including the claims.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular aspect is not necessarily limited to that aspect and can be practiced with any other aspect(s).

The present disclosure relates to modified starches. In particular, the present disclosure relates to unsubstituted crosslinked waxy starches, and in particular to unsubstituted crosslinked starches. The starches of the present disclosure are cold storage stable viscosifying starches that exhibit good freeze-thaw stability. These next generation cold storage stable starches may be made without substitution (e.g., without hydroxypropyl or acetyl substitution), providing improved operational safety, reduced cost of production, and environmental benefits including less wastewater, reduced salt usage, and reduced reaction time and energy usage, thus reducing the carbon footprint and increasing the sustainability of modified starches. The lack of substitution may also help avoid any supply issues with certain industrial chemicals, such as propylene oxide, which is typically used in hydroxypropylation reactions. The cold storage stability of the unsubstituted crosslinked starch of the present disclosure may be comparable to that of hydroxypropyl substituted crosslinked starches. The unsubstituted crosslinked starch of the present disclosure may be used as an alternative or replacement to low hydroxypropyl substituted or medium hydroxypropyl substituted starches or high hydroxypropyl substituted starches.

The unsubstituted crosslinked starch of the present disclosure may be used as an alternative or replacement to acetylated starches.

### Unsubstituted Crosslinked Starch

In one aspect, the present technology provides an unsubstituted crosslinked starch having a hot paste viscosity in a range of about 100 cP to about 1500 cP at measured at pH 3 and about 5.5 wt-% solids, wherein the unsubstituted crosslinked starch has a retrogradation enthalpy of about 3 J/g or less at 1 week and about 7 J/g or less at 4 weeks, and a conclusion temperature of retrogradation of less than about 75° C.

In any aspect, the unsubstituted crosslinked starch may be prepared from waxy tapioca starch. Common tapioca starch contains about 18% to about 23% amylose by weight, the balance being amylopectin. Low amylose tapioca starch contains a higher level of amylopectin and lower level of amylose than common tapioca starch. Waxy tapioca starch also contains a higher level of amylopectin and lower level of amylose than common tapioca starch and may be used here to refer to very low amylose tapioca starch. Waxy tapioca starch may contain about 5 wt-% or less, about 3 wt-% or less, or about 1.5 wt-% or less of amylose or free of amylose Mutants which lack a functional GBSS I gene synthesize an amylose-free starch. The term “GBSS I” is to be understood to mean any enzyme belonging to the group of the granule-bound starch synthase of isoform I (EC 2.4.1.21).

According to an aspect of the present technology, the substituted crosslinked starch may have a chain length distribution according to TABLE 1 below.

TABLE 1
Chain length distribution

| Chain length (Dp) | Weight % |
|---|---|
| Less than 13 Dp | 18% or greater, and up to |
| | 28 wt-% or up to 33 wt-% |
| Dp 13-24 | 48% or less |
| Dp 6-12 | 16% or greater, and up to |
| | 25 wt-% or up to 30 wt-% |
| Dp 6-8 (Afp) | 1.5% or greater |

In TABLE 1, “Dp” refers to degree of polymerization, and “Afp” refers to fingerprint A chains of amylopectin. Afp chains may be referred to as dangling chains, which are too short to participate in the formation of double helices during retrogradation. Fingerprint A-chains (Afp) is a distinct sub-type of the shortest chains of amylopectin at Dp 6-8 and its profile is characteristic of the plant source of the starch. Amylopectin molecules with higher proportion of shorter chains are less susceptible to retrogradation.

Dp may be measured by high performance anion exchange chromatography _(HPAEC) as follows. Starch samples (2 mg) are dissolved in 90% dimethyl sulfoxide (DMSO; 50 μL) and heated in a hot water bath (80° C.) for 5 min and then stirred for 1 h. Warm (80° C.) water (400 μL) is then added to the sample, after which 50 μL of 0.01 M sodium acetate buffer (pH 5.5) is added and allowed to cool to room temperature. Isoamylase (1 μL, 465 U/mL) and 1 μL of pullulanase M1 (925 U/mL) (Megazyme) are added and stirred slowly overnight at room temperature (25° C.) to debranch the starch. After debranching, the enzyme is inactivated by boiling for 5 min, the volume adjusted to obtain a final concentration of 1 mg/mL, and the sample filtered through a 0.45 μm nylon filter. The filtered sample is injected into the HPAEC system equipped with a pulsed amperometric detector, Carbopac PA-100 ion exchange column. The samples are then eluted with a flow rate of 1 mL/min. The sample is eluted by the following gradient of eluent B: 0-9 min, 15-36% B; 9-18 min, 36-45% B; 18-110 min, 45-100% B. The column is equilibrated with 15% B for 60 min between runs. Eluent A was 0.15 M NaOH (7.85 mL/1000 mL) and Eluent B was 0.15 M NaOH containing 0.50 M NaAc (7.85 mL NaOH/41 g NaOAc for 1L).

According to an aspect of the present technology, the unsubstituted crosslinked starch has 18 wt-% or more of chains having a Dp of 13 or lower. The unsubstituted crosslinked starch may have 48 wt-% or less of chains having a Dp of 13-24. The unsubstituted crosslinked starch may have 16 wt-% or more of chains having a Dp of 6-12. The unsubstituted crosslinked starch may have 1.5 wt-% or more of chains having a Dp of 6-8.

Waxy tapioca starch may be obtained from a waxy cassava plant. A recessive waxy cassava mutant has been found in nature. Waxy cassava may be obtained by classical breeding and crossbreeding techniques, or obtained by translocation, inversion, transformation, or any other method of gene or chromosome engineering, including CRISPER/Cas 9 technology. The term CRISPR is used in the art to refer to clustered regularly interspaced short palindromic repeats. CRISPR/Cas9 refers to a CRISPR-associated protein 9. CRISPR/Cas9-mediated targeted mutagenesis of two genes involved in amylose biosynthesis, protein targeting to starch (PTST1) or granule bound starch synthase (GBSS), can reduce or eliminate amylose content in root starch. Waxy tapioca starch may be extracted from the root of a low amylose cassava plant. Extraction may be performed by any known method, such as pulverizing the root and extracting the starch from the pulverized root with water. The extracted starch may be considered to be a native starch that has not been chemically modified.

Substitution of starch is understood to mean chemical derivatization to form ethers, esters, or half esters such as hydroxyalkyl ethers, acetates, phosphates, succinates (e.g., octenyl succinate), tertiary amine ethers, or quaternary amine ethers, etc., by any suitable modification technique. Typically, starch is substituted by reacting the starch with alkylene oxides to form hydroxyalkyl ether derivatives. Etherification of starch improves the functional properties of starches in many ways. Hydroxypropylation and crosslinking are often employed together to produce crosslinked stabilized starches that are widely used for thickening and stabilizing food applications.

According to the present disclosure in any aspect, the starches are unsubstituted. It should be noted that crosslinking is not considered to be a substitution. In any aspect, the starches as described herein may be free of any other modifications (other than crosslinking). The starches of the present disclosure may be characterized as unsubstituted crosslinked starches. For example, the starch may be free of substitutions, enzymatic modifications, pregelatinization, or a combination of any two or more thereof. In any aspect, the starch is free of substitutions, enzymatic modifications, and pregelatinization. In any aspect, the starch is free of substitutions and enzymatic modifications but has been pregelatinized. The unsubstituted crosslinked starches of the present disclosure have been found to be functionally similar to hydroxypropylated crosslinked waxy corn starch in terms of viscosity and cold storage stability. The unsubstituted crosslinked starches help eliminate the typical sodium sulfate waste stream associated with industrial propylene oxide reactions with starch and provide energy saving and increased manufacturing capacity via reduction in reaction time from about 22 h to less than about 8 h.

In any aspect, the starches of the present disclosure are crosslinked. The starch may be crosslinked using a crosslinking agent. Suitable crosslinking agents include epichlorohydrin, linear dicarboxylic acid anhydrides, citric acid, acrolein, sodium trimetaphosphate, phosphorus oxychloride, adipic/acetic mixed acid anhydrides, trimetaphosphate salts, a mixture of sodium trimetaphosphate and sodium tripolyphosphate, linear dicarboxylic acid anhydrides, citric acid, acrolein, adipate, formaldehyde, cyanuric chloride, diisocyanates, divinyl sulfones, and combinations of any two or more thereof. In any aspect, the crosslinking agent includes sodium trimetaphosphate (STMP), phosphorus oxychloride (POCl₃), adipate, epichlorohydrin, or a combination of any two or more thereof. In any aspect, the unsubstituted crosslinked starch is suitable for use in food products. Such starches may be crosslinked using a crosslinking agent suitable for food uses. For example, starch intended for food products may be crosslinked using sodium trimetaphosphate or phosphorus oxychloride or mixture of sodium trimetaphosphate and sodium tripolyphosphate. The unsubstituted crosslinked starch may be provided in any desirable form. In any aspect, the unsubstituted crosslinked starch may be non-gelatinized granular starch.

In another aspect, the unsubstituted crosslinked starch may be used to prepare a non-granular for of the unsubstituted crosslinked starch. According to some aspects of the present technology, the unsubstituted, crosslinked starch may be used to prepare a pre-gelatinized non-granular unsubstituted, crosslinked starch. Pre-gelatinized non granular starch may develop viscosity when dispersed in cold or warm water without the need for further heating. Pre-gelatinized non-granular starch is also known as pre-cooked starch, instant starch, cold water-soluble starch, or cold-water swelling starch. In some aspects, the unsubstituted crosslinked starch may be used to prepare a partially gelatinized. Starch may be partially gelatinized, for example, by spray cooking, drum drying, or extrusion. According to some aspects of the present technology, the unsubstituted crosslinked starch may be used to prepare a cold water swelling or instant product. The unsubstituted crosslinked starch may be used to prepare an agglomerated unsubstituted crosslinked starch. Crosslinked granular starch agglomerates can impart higher viscosity than non-agglomerated crosslinked starch.

### Methods of Making the Unsubstituted Crosslinked Starch

In any aspect, methods of making the unsubstituted crosslinked starches described herein include crosslinking. The methods may also include other process steps discussed herein.

The crosslinking reaction may be carried out using techniques known in the art, such as those described in U.S. Pat. Nos. 2,328,537 and 2,801,242, which are incorporated herein in their entirety. To prepare the unsubstituted crosslinked starch, the native starch may be mixed with an aqueous solvent or water to form a slurry. The native starch may be present at a solids content of about 5 wt-% or greater, about 10 wt-% or greater, about 15 wt-% or greater, about 20 wt-% or greater, about 25 wt-% or greater, about 30 wt-% or greater, or about 35 wt-% or greater by weight of the slurry. The native starch may be present at a solids content of about 45 wt-% or less, about 40 wt-% or less, or about 35 wt-% or less by weight of the slurry. The native starch may be present at a solids content of about 20 wt-% to about 45 wt-%, about 30 wt-% to about 45 wt-%, or from about 30 wt-% to about 40 wt-% by weight of the slurry. The pH of the slurry may be adjusted to be alkaline. For example, the pH of the slurry may be adjusted to a range of about 10 to about 13 or from about 11 to about 12. The pH of the slurry may be adjusted with any suitable base that does not interfere with the reaction. For example, the pH of the slurry may be adjusted using sodium hydroxide (NaOH), potassium hydroxide (KOH), sodium carbonate (Na₂CO₃), potassium carbonate (K₂CO₃), or a combination of any two or more thereof. The slurry may also include a salt, such as sodium chloride (NaCl), sodium sulfate (Na₂SO₄), calcium chloride (CaCl₂), or a combination of any two or more thereof. Salt may be used to control the granular swelling of the starch. The inclusion of salt may also enhance the crosslinking reaction. The salt may be included in the slurry at a concentration of 0.5 wt-% or greater, about 1 wt-% or greater, about 2 wt-% or greater, about 3 wt-% or greater, or about 4 wt-% or greater. The salt may be included in the slurry at a concentration of about 10 wt-% or less, about 8 wt-% or less, about 7 wt-% or less, or about 6 wt-% or less.

The crosslinking agent may be mixed into the slurry at a suitable concentration depending on the crosslinking agent and the desired degree of crosslinking. The degree of crosslinking may be adjusted based on the desired viscosity. When comparing otherwise similar starches, a starch with a higher degree of crosslinking exhibits a higher viscosity than a starch with a lower degree of crosslinking. In any aspect, the amount of crosslinking agent is limited by regulatory limits on certain compounds, such as phosphates, in food products. The amount of crosslinking agent in the slurry may range from 0.001 wt-% to about 1.0 wt-% or from 0.008 wt-% to 0.1 wt-% on a dry weight basis. In any aspect, the amount of crosslinking agent in the slurry is 0.5 wt-% or less, 0.4 wt-% or less, 0.25 wt-% or less, or 0.1 wt-% or less, on a dry weight basis. The amount of crosslinking agent in the slurry may range from 0.01 wt-% to 0.1 wt-%. In any aspect, the amount of crosslinking agent is limited based on the amount present in the final product. For example, the amount of residual phosphate may be limited in food products and food ingredients. The amount of crosslinking agent in the final product (e.g., crosslinked starch) may be 0.4 wt-% or less, 0.1 wt-% or less, or 0.04 wt-% or less, calculated as phosphorus. The crosslinking reaction conditions may include an elevated temperature, such as a temperature of about 25° C. or higher, about 28° C. or higher, or about 32° C. or higher. The crosslinking temperature may be about 60° C. or lower, or about 50° C. or lower. The duration of the crosslinking reaction may depend on the crosslinking agent and the desired degree of crosslinking. In some cases, the duration of the crosslinking reaction may be as short as about 5-15 minutes (e.g., about 10 minutes). In some aspects, the duration may be longer than about 15 min, such as about 30 min or longer, about 60 min or longer, about 2 hours or longer, about 3 hours or longer, about 4 hours or longer, or about 5 hours or longer. The duration may be about 24 hours or less, about 18 hours or less, about 12 hours or less, about 10 hours or less, or about 8 hours or less. The slurry may further be held at the reaction temperature for an additional time period (a hold time). The hold time may be about 10 min or longer, about 20 min or longer, about 30 min or longer, or about 45 min or longer. The hold time may be up to about 24 hours, up to about 12 hours, up to about 6 hours, up to about 3 hours, up to about 2 hours, or up to about 1.5 hours. The hold time may be, for example, about 1 hour.

After the crosslinking reaction, the pH of the slurry may be adjusted back down. For example, the pH of the slurry may be adjusted to a range of pH about 4 to about 7.5, about 4.5 to about 6.5, or about 5 to about 6. In any aspect, the pH of the slurry may be adjusted to about pH about 5.5. The pH of the slurry may be adjusted using any suitable acid, such as hydrochloric acid (HCl), phosphoric acid (H₃PO₄), citric acid, acetic acid, sulfuric acid, or the like, or a combination of any two or more thereof.

According to any aspect of the present disclosure, the chemical modification of the starch includes crosslinking only. The chemical modification of the starch may be free of substitution reactions, such as hydroxypropylation and acetylation. The unsubstituted crosslinked starch may subsequently be dewatered and dried. Any suitable dewatering and drying methods may be used. In any aspect, the unsubstituted crosslinked starch may be is non-gelatinized granular starch.

In another aspect, the unsubstituted crosslinked starch prepared according to the methods of making described herein may be subjected to further processing to provide the unsubstituted, crosslinked starch in a desirable form. In any aspect, the unsubstituted crosslinked starch may be subjected to further processing to obtain a non-granular unsubstituted, crosslinked starch. According to some aspects of the present technology, the unsubstituted, crosslinked starch may be subjected to further processing to obtain a pre-gelatinized non-granular unsubstituted, crosslinked starch. Pre-gelatinized non granular starch may be made by drum drying, jet cooking and spray drying, or extrusion. Pre-gelatinized non granular starch may develop viscosity when dispersed in cold or warm water without the need for further heating. Pre-gelatinized non-granular starch is also known as pre-cooked starch, instant starch, cold water-soluble starch, or cold-water swelling starch. In any aspect, the unsubstituted crosslinked starch may be subjected to further processing to obtain a partially gelatinized unsubstituted, crosslinked startch. Starch may be partially gelatinized, for example, by spray cooking, drum drying, or extrusion. In any aspect, the unsubstituted crosslinked starch may be further processed to obtain a cold water swelling or instant product. Non-granular starches may be prepared by jet cooking and spray drying, roll (drum) drying, or any other thermal technology known to the skilled person. The unsubstituted crosslinked starch may be further processed to obtain an agglomerated unsubstituted, crosslinked starch. Agglomerated starch is a granular or instant starch that has been processed to produce granular agglomerates. A second material such as native starch or starch derivatives (e.g., maltodextrin, dextrin, or the like) may be included to serve as a binder or inter-particle adhesive.

### Properties of the Unsubstituted Crosslinked Starch

The unsubstituted crosslinked starches, according to any aspect of the present technology, may exhibit various desired properties. The properties described herein may apply to any of the unsubstituted crosslinked starches, including unsubstituted crosslinked starches.

The properties of the starch may be characterized by various measurements. For example, the properties of the starch may be characterized by measuring its hot paste viscosity, retrogradation enthalpy, retrogradation conclusion temperature, or a combination of any two or more thereof.

The ability of a starch to withstand heating and shear stress is a relevant attribute for most food processing operations. Holding strength or hot paste viscosity (HPV) reflects the shear stability of starch granules. Hot paste viscosity is typically measured at a low pH (e.g., at pH 3), or at a neutral or near neutral pH (e.g., at pH about 6). Hot paste viscosity may be measured using a Rapid Visco Analyzer (RVA). The RVA is a heating and cooling viscometer that measures the viscosity of a sample over a given period of time while it is stirred. As used herein, the hot paste viscosity of a sample refers to the viscosity at the end of a holding time (e.g., 20 min) at 95° C. Retrogradation enthalpy may be measured using differential scanning calorimetry (DSC). Retrogradation enthalpy may be measured at various time intervals, such as at one week of storage and at four weeks of refrigerated storage.

According to any aspect of the present disclosure, the unsubstituted crosslinked starch has a hot paste viscosity (measured at pH 3 and 5.5 wt-% solids) of about 90 cP or greater, about 100 cP or greater, about 200 cP or greater, about 300 cP or greater, about 400 cP or greater, about 500 cP or greater, about 600 or greater, about 700 or greater, or about 750 cP or greater. The unsubstituted crosslinked starch may have a hot paste viscosity (measured at pH 3 and 5.5 wt-% solids) of about 1500 cP or less, about 1400 cP or less, about 1300 cP or less, about 1200 cP or less, about 1100 cP or less, about 1000 cP or less, or about 900 cP or less. The hot paste viscosity of the unsubstituted crosslinked starch may be in a range of about 100 cP to about 1500 cP, about 300 cP to about 1300 cP, about 400 cP to about 1200 cP, about 500 cP to about 1200 cP, about 600 cP to about 1200 cP, about 600 cP to about 1000 cP, about 400 cP to about 900 cP, or about 600 cP to about 900 cP.

According to any aspect of the present disclosure, the unsubstituted crosslinked starch has a low retrogradation enthalpy and low retrogradation conclusion temperature. Low retrogradation conclusion temperature and low retrogradation enthalpy indicate that the starch is less prone to retrogradation. Low retrogradation conclusion temperature and low retrogradation enthalpy indicate that the starch has good cold storage stability. The retrogradation enthalpy of the unsubstituted crosslinked starch of the present disclosure may be low (e.g., lower than previously known starches) at both 1 week and at 4 weeks of refrigerated storage. According to any aspect of the present disclosure, the unsubstituted crosslinked starch has a retrogradation enthalpy of about 3 J/g or less, about 2.8 J/g or less, about 2.5 J/g or less, about 2.4 J/g or less, about 2.3 J/g or less, about 2.2 J/g or less, about 2.1 J/g or less, or about 2.0 J/g or less, measured at 1 week of refrigerated storage. The unsubstituted crosslinked starch may have a retrogradation enthalpy of 0.7 J/g or greater, 0.8 J/g or greater, 0.9 J/g or greater, or about 1.0 J/g or greater, measured at 1 week of refrigerated storage. The unsubstituted crosslinked starch may have a retrogradation enthalpy of 0.7 J/g to about 3 J/g, 0.8 J/g to about 2.5 J/g, 0.8 J/g to about 2.4 J/g, or about 1.0 J/g to about 2.3 J/g, measured at 1 week of storage. At 4 weeks of refrigerated storage, the unsubstituted crosslinked starch may have a retrogradation enthalpy of about 7 J/g or less, about 6.7 J/g or less, about 6.5 J/g or less, about 6.3 J/g or less, about 6.2 J/g or less, about 6.1 J/g or less, or about 6.0 J/g or less. The unsubstituted crosslinked starch may have a retrogradation enthalpy of about 3.0 J/g or greater, about 3.5 J/g or greater, about 3.8 J/g or greater, or about 4.0 J/g or greater, measured at 4 weeks of refrigerated storage. The unsubstituted crosslinked starch may have a retrogradation enthalpy of about 3.0 J/g to about 7 J/g, about 3.5 J/g to about 6.7 J/g, or about 4.0 J/g to about 6.5 J/g, measured at 4 weeks of refrigerated storage. In any aspect, the unsubstituted crosslinked starch has a retrogradation enthalpy of about 3 J/g or less measured at 1 week of storage and about 7 J/g or less measured at 4 weeks of refrigerated storage. In any aspect, the unsubstituted crosslinked starch has a retrogradation enthalpy of about 2.5 J/g or less measured at 1 week of storage and about 6.5 J/g or less measured at 4 weeks of refrigerated storage. In any aspects, the unsubstituted crosslinked starch has a retrogradation enthalpy of about 2.0 J/g or less measured at 1 week of storage and about 6.0 J/g or less measured at 4 weeks of refrigerated storage.

The unsubstituted crosslinked starch may have a conclusion temperature of retrogradation of about 90° C. or less, about 85° C. or less, about 80° C. or less, about 75° C. or less, or about 70° C. or less. The conclusion temperature of retrogradation may be about 50° C. or greater.

The retrogradation enthalpy of the unsubstituted crosslinked starch may also be compared to the gelatinization enthalpy of the starch. The unsubstituted crosslinked starch may have a retrogradation enthalpy, measured at 1 week of refrigerated storage, that is about 25% or less, 20% or less, 15% or less, 10% or less, or 5% or less of the gelatinization enthalpy of the starch. The unsubstituted crosslinked starch may have a retrogradation enthalpy, measured at 4 weeks of refrigerated storage, that is about 60% or less, about 50% or less, or about 40% or less of the gelatinization enthalpy of the starch. The retrogradation enthalpy, measured at 4 weeks of refrigerated storage, may be from 20% to 60%, 30% to 60%, 40% to 60%, or 50% to 60% of the gelatinization enthalpy of the starch.

According to any aspect of the present disclosure, the unsubstituted crosslinked starch has good freeze-thaw stability. A freeze-thaw cycle is considered to be the combination of freezing and thawing of a composition, such as a food product, that includes the starch. The starch may be stable through 2 or more, 3 or more, 4 or more, 5 or more, 6 or more, 8 or more, or 10 or more freeze-thaw cycles. While there may not be a desired upper limit on the number of freeze-thaw cycles for starch stability, the starch may be stable through up to 12 freeze-thaw cycles. In any aspect, the starch is stable through 4 to 12 freeze-thaw cycles. Stability through freeze-thaw cycles may be evaluated visually by observing whether any water has separated from the product due to the storage conditions (which may include one or more freeze-thaw cycles). If no water separation is observed either on surface or when sample is pressed, the product is considered stable in the tested storage conditions.

In any aspect, the unsubstituted crosslinked starch has a hot paste viscosity in a range of about 100 cP to about 1500 cP (measured at pH 3 and 5.5 wt-% solids), a retrogradation enthalpy of about 2.3 J/g or less at 1 week and about 7 J/g or less at 4 weeks, and conclusion temperature of retrogradation of less than about 75° C. In some cases, the unsubstituted crosslinked starch has a hot paste viscosity in a range of about 300 cP to about 1300 cP at (measured pH 3 and 5.5 wt-% solids), a retrogradation enthalpy of about 2.2 J/g or less at 1 week and about 6.8 J/g or less at 4 weeks, and conclusion temperature of retrogradation of less than about 75° C. In some cases, the unsubstituted crosslinked starch has a hot paste viscosity in a range of about 400 cP to about 900 cP (measured at pH 3 and 5.5 wt-% solids), a retrogradation enthalpy of about 2.1 J/g or less at 1 week and about 6.5 J/g or less at 4 weeks, and conclusion temperature of retrogradation of less than about 75° C.

The unsubstituted crosslinked starch may be prepared from any suitable waxy starch source. The term “native starch” is used there to refer to the starch source that the unsubstituted crosslinked starch is prepared from. The unsubstituted crosslinked starch may be prepared from a native starch that includes about 10 wt-% or less, about 5 wt-% or less, about 4 wt-% or less, about 3 wt-% or less, about 2 wt-% or less, or about 1 wt-% or less of amylose. The native starch may be free or substantially free of amylose. In any aspect, the unsubstituted crosslinked starch is prepared from waxy tapioca, waxy rice, waxy-sugary-2 corn mutant, short chain waxy potato (recognized by the lack of or non-functional GBSS1 combined with deficient or non-functional SSII and/or SSIII enzymes), waxy wheat, high phosphorylated waxy starch, or a combination of any two or more thereof. Waxy-sugary-2 is a double-mutant corn plant, where the corn plant is either homozygous or heterozygous recessive for the starch synthase IIa (su2) gene, and either homozygous or heterozygous for a mutated Granule-bound starch synthase I (GBSSI) gene, where the mutated GBSSI gene has less activity or no GBSSI activity. Mutated corn plant with less activity of GBSSI gene can produce less than about 10% amylose content, whereas no activity of GBSSI gene can produce less than about 2% or zero amylose content. In any aspect, unsubstituted crosslinked starch is prepared from waxy tapioca starch. The waxy tapioca starch may be obtained from a naturally occurring waxy cassava plant or a waxy cassava plant developed by non-genetic modification (non-GM) or conventional breeding. The waxy tapioca starch may be obtained from a cassava plant modified using CRISPER/Cas 9 technology. In any aspect, unsubstituted crosslinked starch is prepared from high phosphorylated waxy starches from potato, tapioca, corn, wheat, rice, or a combination of any two or more thereof.

### Use of the Unsubstituted Crosslinked Starch

The unsubstituted crosslinked starches, according to any aspect of the present technology, may be used in various ways to provide desired properties to products. The uses described herein may apply to any of the unsubstituted crosslinked starches, including unsubstituted crosslinked starches. The unsubstituted crosslinked starch may be formulated for use in food products, pet food products, or non-food products. The unsubstituted crosslinked starch may be used in food products, nutritional products, pharmaceutical products, personal care products, paper products, and the like. In any aspect, the unsubstituted crosslinked starch is formulated for human consumption.

The unsubstituted crosslinked starch may be used in food products to impart better cold storage stability, thermal stability, thickening, increased viscosity, or a combination of any two or more thereof. For example, the unsubstituted crosslinked starch may be formulated for use in a dairy product, such as yogurt, sour cream, a fruit preparation, a dairy-based dessert, a pudding, or the like. The unsubstituted crosslinked starch may be formulated for use in a non-dairy yogurt, a non-dairy pudding, or other non-dairy deserts. The unsubstituted crosslinked starch may be formulated for use in a sauce, a gravy, a dressing, a dip, a spread, a bakery filling, a dry mix, or the like. The unsubstituted crosslinked starch may be used in food products such as cereals, breads, bread products, cheese, cheese products, condiments, confectioneries, dressings, pie fillings, sauces, cheese sauces, gravies, imitation syrups, puddings, custards, yogurts, sour creams and sour cream products, pastas, beverages, glazes, soups, baby foods, and the like. The food product may be formulated for processing and storage conditions such as retorting, aseptically filling packaging, refrigeration, freezing, or a combination of any two or more thereof.

The unsubstituted crosslinked starch may be formulated for use in a pet food, a retort food (e.g., retort pet food or any other food packaged in retort type packaging), or a canned pet food.

The unsubstituted crosslinked starch may be used in paper products such as paper, paperboard, linerboard, corrugated board, cardboard, and the like.

The unsubstituted crosslinked starch may be used in pharmaceutical or nutritional products to act as binders, disintegrants, diluents, tableting agents, dusting powders, or the like.

The unsubstituted crosslinked starch may be used in personal care products such as deodorants, antiperspirants, hair sprays, gels, mousses, lotions, pomades, soaps, cleansers, shampoos, conditioners, mouthwashes, breath fresheners, toothpastes, and makeup products such as eye shadows, powders, foundations, blushers, and the like.

According to any aspect of the present disclosure, a food product includes the unsubstituted crosslinked starch. The food product may be a food product intended for human consumption or a pet food or animal feed. The food product may be a dairy product, such as yogurt, sour cream, a fruit preparation, a dairy-based dessert, a pudding, or the like. The food product may be a non-dairy yogurt or non-dairy pudding. The food product may be a sauce, a gravy, a dressing, a dip, a spread, a bakery filling, a dry mix, or the like. The food product may be a pet food, a retort food, or a canned pet food. The unsubstituted crosslinked starch may be used in the food product at any suitable concentration to achieve a desired property or quality affected by the presence of the unsubstituted crosslinked starch. For example, the unsubstituted crosslinked starch may be included at about 1 wt-% or greater, about 2 wt-% or greater, about 5 wt-% or greater, about 7.5 wt-% or greater, about 10 wt-% or greater, about 12.5 wt-% or greater, about 15 wt-% or greater, or about 20 wt-% or greater based on the total weight of the food product. The unsubstituted crosslinked starch may be included at about 35 wt-% or less, about 30 wt-% or less, about 25 wt-% or less, about 20 wt-% or less, about 15 wt-% or less, or about 10 wt-% or less based on the total weight of the food product. In any aspect, the unsubstituted crosslinked starch is makes up from about 1 wt-% to about 35 wt-% or about 5 wt-% to about 25 wt-% of the food product. In dry mixes, such as those intended for sauces, ready meals, bakery fillings, and the like, the starch content may be at the high end of the range, for example from about 10 wt-% to about 35 wt-% or even higher, such as about 10 wt-% to about 50 wt-%, about 20 wt-% to about 50 wt-%, or about 35 wt-% to about 50 wt-%. The main function of the starch in these applications is to thicken and create a paste texture. Lower concentrations may be used, for example, in dairy drinks, such as fermented, acidified, or neutral dairy drinks and their alternatives. The amount of starch in such products may range from 0.2 wt-% to about 1 wt-%. The function of the starch in these applications is to provide body and enhance mouthfeel. In yogurt, the starch may be included at a concentration of about 1 wt-% to about 2.5 wt-%. The function of the starch in these applications is to bind water (provide thickening), and to provide texture and help prevent syneresis. In soups and sauces (whether emulsified or not), the starch may be included at a concentration of about 1 wt-% to about 6 wt-%. The function of the starch in these applications is to bind water, increase viscosity, and create texture. In fruit preparation, the starch may be included at a concentration of about 3 wt-% to about 6 wt-%. The function of the starch in these applications is to provide thickening and to create a creamy texture (paste) and helps prevent syneresis.

### Exemplary Aspects

The following list provides exemplary aspects and various combinations of aspects according to the present disclosure.

According to Aspect 1, an unsubstituted crosslinked (e.g., crosslinked) starch, having hot paste viscosity in a range of about 100 cP to about 1500 cP (measured at pH 3 and 5.5 wt-% solids), a retrogradation enthalpy of about 2.8 J/g or less at 1 week and about 7 J/g or less at 4 weeks, and conclusion temperature of retrograded starch of less than about 75° C.

Aspect 2 is the unsubstituted crosslinked starch of Aspect 1, wherein the unsubstituted crosslinked starch is prepared from waxy tapioca, waxy rice, waxy-sugary-2 corn mutant, short chain waxy potato, waxy wheat, high phosphorylated waxy starch, or a combination of any two or more thereof.

Aspect 3 is the unsubstituted crosslinked starch of Aspect 1 or 2, wherein the starch is crosslinked.

Aspect 4 is the unsubstituted crosslinked starch of any one of Aspects 1 to 3, wherein the unsubstituted crosslinked starch comprises unsubstituted, crosslinked waxy tapioca starch.

Aspect 5 is the unsubstituted crosslinked starch of any one of Aspects 1-4, wherein the unsubstituted, crosslinked modified starch is prepared from a waxy tapioca starch crosslinked using epichlorohydrin, a linear dicarboxylic acid anhydride, citric acid, acrolein, phosphorus oxychloride, an adipic/acetic mixed acid anhydride, trimetaphosphate salt, sodium trimetaphosphate, a mixture of sodium trimetaphosphate and sodium tripolyphosphate, a linear dicarboxylic acid anhydride, citric acid, acrolein, adipate, formaldehyde, cyanuric chloride, diisocyanate, divinyl sulfone, or a combination of any two or more thereof.

Aspect 6 is the unsubstituted crosslinked starch of any one of Aspects 1-5, wherein the unsubstituted crosslinked starch is prepared from a waxy tapioca starch crosslinked using a crosslinking agent comprising sodium trimetaphosphate, phosphorus oxychloride, adipate, epichlorohydrin, or a combination of any two or more thereof.

Aspect 7 is the unsubstituted crosslinked starch of any one of Aspects 1-6, wherein the unsubstituted, crosslinked starch is prepared from a waxy tapioca starch crosslinked using a crosslinking agent consisting of sodium trimetaphosphate, phosphorus oxychloride, or a combination thereof.

Aspect 8 is the unsubstituted crosslinked starch of any one of Aspects 1 to 7, wherein the hot paste viscosity (measured at pH 3 and 5.5 wt-% solids) is about 200 cP or greater, about 300 cP or greater, about 400 cP or greater, about 500 cP or greater, about 600 or greater, about 700 or greater, or about 750 cP or greater.

Aspect 9 is the unsubstituted crosslinked starch of any one of Aspects 1 to 8, wherein the hot paste viscosity (measured at pH 3 and 5.5 wt-% solids) is about 1400 cP or less, about 1300 cP or less, about 1200 cP or less, about 1100 cP or less, about 1000 cP or less, or about 900 cP or less.

Aspect 10 is the unsubstituted crosslinked starch of any one of Aspects 1 to 9, wherein the hot paste viscosity (measured at pH 3 and 5.5 wt-% solids) is in a range of about 300 cP to about 1300 cP, about 400 cP to about 1200 cP, about 500 cP to about 1200 cP, about 600 cP to about 1200 cP, about 600 cP to about 1000 cP, about 400 cP to about 900 cP, or about 600 cP to about 900 cP.

Aspect 11 is the unsubstituted crosslinked starch of any one of Aspects 1 to 10, wherein the retrogradation enthalpy is about 2.5 J/g or less, about 2.4 J/g or less, about 2.3 J/g or less, about 2.2 J/g or less, about 2.1 J/g or less, or about 2.0 J/g or less, measured at 1 week of refrigerated storage.

Aspect 12 is the unsubstituted crosslinked starch of any one of Aspect 1-11, wherein the retrogradation enthalpy is about 2.3 J/g or less, measured at 1 week of refrigerated storage.

Aspect 13 is the unsubstituted crosslinked starch of any one of Aspects 1 to 12, wherein the retrogradation enthalpy is about 0.7 J/g or greater, about 0.8 J/g or greater, about 0.9 J/g or greater, or about 1.0 J/g or greater, measured at 1 week of refrigerated storage.

Aspect 14 is the unsubstituted crosslinked starch of any one of Aspects 1 to 13, wherein the retrogradation enthalpy is about 6.7 J/g or less, about 6.5 J/g or less, about 6.3 J/g or less, about 6.2 J/g or less, about 6.1 J/g or less, or about 6.0 J/g or less, measured at 4 weeks of refrigerated storage.

Aspect 15 is the unsubstituted crosslinked starch of any one of Aspects 1 to 14, wherein the unsubstituted crosslinked starch comprises about 10 wt-% or less, about 5 wt-% or less, about 3 wt-% or less, about 2 wt-% or less, about 1.5 wt-% or less, or no amylose.

Aspect 16 is the unsubstituted crosslinked starch of any one of Aspects 1 to 15, wherein the unsubstituted crosslinked starch is substantially free of amylose.

Aspect 17 is the unsubstituted crosslinked starch of any one of Aspects 1-16, wherein the unsubstituted, crosslinked starch is prepared from a waxy tapioca starch, wherein the waxy tapioca starch is prepared from a cassava plant modified using CRISPER/Cas 9 technology.

Aspect 18 is the unsubstituted crosslinked starch of any one of Aspects 1-16, wherein the unsubstituted, crosslinked starch is prepared from a waxy tapioca starch, wherein the waxy tapioca starch is prepared from a naturally occurring waxy cassava plant or a waxy cassava plant developed by non-genetic modification or conventional breeding.

Aspect 19 is the unsubstituted crosslinked starch of any one of Aspects 1 to 18, wherein the starch is not hydroxypropylated or acetylated.

Aspect 20 is the unsubstituted crosslinked starch of any one of Aspects 1 to 19, wherein the starch is granular.

Aspect 21 is the unsubstituted crosslinked starch of any one of Aspects 1 to 21, wherein the starch is stable through 2 or more, 3 or more, 4 or more, 5 or more, 6 or more, 8 or more, or 10 or more freeze-thaw cycles.

Aspect 22 is the unsubstituted crosslinked starch of any one of Aspects 1 to 22, wherein the starch is stable through 2 to 12, 3 to 12, 4 to 12, 5 to 12, 6 to 12, 8 to 12, or 10 to 12 freeze-thaw cycles.

Aspect 23 is A pregelatinized non-granular or partially gelatinized or agglomerated product prepared using the unsubstituted crosslinked starch of any one of Aspects 1 to 20.

Aspect 24 is a food product comprising the unsubstituted crosslinked starch of any one of Aspects 1 to 23.

Aspect 25 is the food product of Aspect 24, wherein the food product is a dairy product.

Aspect 26 is the food product of Aspect 25, wherein the dairy product comprises yogurt, sour cream, a fruit preparation, a dairy-based dessert, a pudding, or a combination of any two or more thereof.

Aspect 27 is the food product of Aspect 24, wherein the food product is a non-dairy yogurt or non-dairy pudding.

Aspect 28 is the food product of Aspect 24, wherein the food product comprises a sauce, a gravy, a dressing, a dip, a spread, a bakery filling, or a dry mix.

Aspect 29 is the food product of Aspect 24, wherein the food product comprises a pet food, a retort food, or a canned pet food.

Aspect 30 is the food product of any one of Aspects 24 to 29, wherein the unsubstituted crosslinked starch makes up from about 1 wt-% to about 35 wt-%, about 5 wt-% to about 25 wt, about 10 wt-% to about 35 wt-%, about 10 wt-% to about 50 wt-%, about 20 wt-% to about 50 wt-%, or about 35 wt-% to about 50 wt-% of the food product.

Aspect 31 is the food product of any one of Aspects 24 to 30, wherein the food product comprises a dairy drink, such as a fermented, acidified, or neutral dairy drink and the unsubstituted crosslinked starch makes up from about 0.2 wt-% to about 1 wt-% of the food product.

Aspect 32 is the food product of any one of Aspects 24 to 30, wherein the food product comprises yogurt and the unsubstituted crosslinked starch makes up from about 1 wt-% to about 2.5 wt-% of the food product.

Aspect 33 is the food product of any one of Aspects 24 to 30, wherein the food product comprises a soup or sauce and the unsubstituted crosslinked starch makes up from about 1 wt-% to about 6 wt-% of the food product.

Aspect 34 is the food product of any one of Aspects 24 to 30, wherein the food product comprises fruit preparation and the unsubstituted crosslinked starch makes up from about 3 wt-% to about 6 wt-% of the food product.

Aspect 35 is a method of making an unsubstituted crosslinked starch, the method comprising:
mixing a native starch with water to form a slurry;
adjusting pH of the slurry to alkaline; and
mixing a crosslinking agent with the slurry to effect a crosslinking reaction,
wherein the resulting unsubstituted crosslinked starch exhibits hot paste viscosity in a range of about 100 cP to about 1500 cP, a retrogradation enthalpy of about 2.8 J/g or less at 1 week and about 7 J/g or less at 4 weeks, and conclusion temperature of retrograded starch of less than about 75° C.

Aspect 36 is the method of Aspect 35, wherein the slurry comprises about 45 wt-% or less, about 40 wt-% or less, or about 35 wt-% or less of native starch dry solids by weight of the slurry.

Aspect 37 is the method of Aspect 35 or 36, wherein the slurry comprises about 20 wt-% to about 45 wt-%, about 30 wt-% to about 45 wt-%, or from about 30 wt-% to about 40 wt-% of native starch dry solids by weight of the slurry.

Aspect 38 is the method of any one of Aspects 35 to 37, wherein the pH is adjusted to a range of about 10 to about 13 or about 11 to about 12.

Aspect 39 is the method of any one of Aspects 35 to 38, wherein the crosslinking reaction comprises a reaction temperature of about 25° C. or higher, about 28° C. or higher, or about 32° C. or higher.

Aspect 40 is the method of any one of Aspects 35 to 39, wherein the crosslinking reaction comprises a reaction temperature of about 60° C. or lower or about 50° C. or lower.

Aspect 41 is the method of any one of Aspects 35 to 40, wherein the crosslinking reaction comprises a reaction temperature of about 24° C. to about 45° C.

Aspect 42 is the method of any one of Aspects 35 to 41, wherein the crosslinking reaction has a duration of about 15 min or longer, about 30 min or longer, about 60 min or longer, about 2 hours or longer, about 3 hours or longer, about 4 hours or longer, or about 5 hours or longer.

Aspect 43 is the method of any one of Aspects 35 to 42, wherein the crosslinking reaction has a duration of about 24 hours or less, about 18 hours or less, about 12 hours or less, about 10 hours or less, or about 8 hours or less.

Aspect 44 is the method of any one of Aspects 35 to 43, wherein the crosslinking reaction comprises a hold time of about 10 min or longer, about 20 min or longer, about 30 min or longer, or about 45 min or longer.

Aspect 45 is the method of any one of Aspects 35 to 44, wherein the crosslinking reaction comprises a hold time of up to about 24 hours, up to about 12 hours, up to about 6 hours, up to about 3 hours, up to about 2 hours, or up to about 1.5 hours.

Aspect 46 is the method of any one of Aspects 35 to 45, wherein the crosslinking reaction comprises a duration of about 0.5 h to about 10 h and a hold time of about 10 min to about 2 hours.

Aspect 47 is the method of any one of Aspects 35 to 46, wherein the crosslinking agent comprises epichlorohydrin, a linear dicarboxylic acid anhydride, citric acid, acrolein, phosphorus oxychloride, an adipic/acetic mixed acid anhydride, trimetaphosphate salt, sodium trimetaphosphate, a mixture of sodium trimetaphosphate and sodium tripolyphosphate, a linear dicarboxylic acid anhydride, citric acid, acrolein, adipate, formaldehyde, cyanuric chloride, diisocyanate, divinyl sulfone, or a combination of any two or more thereof.

Aspect 48 is the method of any one of Aspects 35 to 47, wherein the crosslinking agent comprises sodium trimetaphosphate, phosphorus oxychloride, adipate, epichlorohydrin, citric acid or a combination of any two or more thereof.

Aspect 49 is the method of any one of Aspects 35 to 48, wherein the crosslinking agent consists of sodium trimetaphosphate, phosphorus oxychloride, citric acid or a combination thereof.

Aspect 50 is the method of any one of Aspects 35 to 49, wherein the crosslinking agent is included in the slurry at a concentration of about 0.001 wt-% to about 1.0 wt-% or from about 0.008 wt-% to about 0.1 wt-% on a dry weight basis.

Aspect 51 is the method of any one of Aspects 35 to 50, wherein the crosslinking agent is included in the slurry at a concentration of about 0.5 wt-% or less, about 0.4 wt-% or less, about 0.25 wt-% or less, or about 0.1 wt-% or less, on a dry weight basis.

Aspect 52 is the method of any one of Aspects 35 to 51, wherein the slurry comprises about 0.5 wt-% or greater, about 1 wt-% or greater, about 2 wt-% or greater, about 3 wt-% or greater, or about 4 wt-% or greater of salt.

Aspect 53 is the method of any one of Aspects 35 to 52, wherein the slurry comprises about 10 wt-% or less, about 8 wt-% or less, about 7 wt-% or less, or about 6 wt-% or less of salt.

Aspect 54 is the method of any one of Aspects 35 to 53, wherein the slurry comprises from about 0.5 wt-% to about 10 wt-% of salt.

Aspect 55 is the method of any one of Aspects 52 to 54, wherein the salt comprises sodium hydroxide (NaOH), potassium hydroxide (KOH), sodium carbonate (Na₂CO₃), potassium carbonate (K₂CO₃), or a combination of any two or more thereof.

Aspect 56 is the method of any one of Aspects 35 to 55 further comprising adjusting the pH after crosslinking to a range of 4 to 7.5, 4.5 to 6.5, or 5 to 6.

Aspect 57 is the method of any one of Aspects 35 to 56 further comprising dewatering and drying the starch.

Aspect 58 is the method of any one of Aspects 35 to 57, wherein the native starch comprises waxy tapioca, waxy rice, waxy-sugary-2 corn mutant, short chain waxy potato, waxy wheat, high phosphorylated waxy starch, or a combination of any two or more thereof.

Aspect 59 is the method of any one of Aspects 35 to 58, wherein the native starch comprises about 10 wt-% or less, about 5 wt-% or less, about 3 wt-% or less, about 2 wt-% or less, about 1.5 wt-% or less, or 0 wt-% amylose.

Aspect 60 is the method of any one of Aspects 35 to 59, wherein the native starch is free, or substantially free, of amylose.

Aspect 61 is the method of any one of Aspects 35 to 60, wherein the unsubstituted crosslinked starch comprises unsubstituted crosslinked waxy tapioca starch.

Aspect 62 is the method of any one of Aspects 35 to 61, wherein the unsubstituted crosslinked starch exhibits a hot paste viscosity (measured at pH 3 and 5.5 wt-% solids) of about 200 cP or greater, about 300 cP or greater, about 400 cP or greater, about 500 cP or greater, about 600 or greater, about 700 or greater, or about 750 cP or greater.

Aspect 63 is the method of any one of Aspects 35 to 62, wherein the unsubstituted crosslinked starch exhibits a hot paste viscosity (measured at pH 3 and 5.5 wt-% solids) of about 1400 cP or less, about 1300 cP or less, about 1200 cP or less, about 1100 cP or less, about 1000 cP or less, or about 900 cP or less.

Aspect 64 is the method of any one of Aspects 35 to 63, wherein the unsubstituted crosslinked starch exhibits a hot paste viscosity (measured at pH 3 and 5.5 wt-% solids) of about 300 cP to about 1300 cP, about 400 cP to about 1200 cP, about 500 cP to about 1200 cP, about 600 cP to about 1200 cP, about 600 cP to about 1000 cP, about 400 cP to about 900 cP, or about 600 cP to about 900 cP.

Aspect 65 is the method of any one of Aspects 35 to 64, wherein the retrogradation enthalpy is about 2.5 J/g or less, about 2.4 J/g or less, about 2.3 J/g or less, about 2.2 J/g or less, about 2.1 J/g or less, or about 2.0 J/g or less, measured at 1 week of refrigerated storage.

Aspect 66 is the method of any one of Aspects 35 to 65, wherein the retrogradation enthalpy is about 2.3 J/g or less, measured at 1 week of refrigerated storage.

Aspect 67 is the method of any one of Aspects 35 to 66, wherein the retrogradation enthalpy is about 0.7 J/g or greater, about 0.8 J/g or greater, about 0.9 J/g or greater, or about 1.0 J/g or greater, measured at 1 week of refrigerated storage.

Aspect 68 is the method of any one of Aspects 35 to 67, wherein the retrogradation enthalpy is about 6.7 J/g or less, about 6.5 J/g or less, about 6.3 J/g or less, about 6.2 J/g or less, about 6.1 J/g or less, or about 6.0 J/g or less, measured at 4 weeks of refrigerated storage.

Aspect 69 is the method of any one of Aspects 35 to 68, wherein the method does not include substitution of the starch.

Aspect 70 is the method of any one of Aspects 35 to 69, wherein the method does not include hydroxypropylation or acetylation.

Aspect 71 is a nutritional product comprising the unsubstituted crosslinked starch of any one of Aspects 1 to 23.

Aspect 72 is a pharmaceutical product comprising the unsubstituted crosslinked starch of any one of Aspects 1 to 23.

Aspect 73 is a personal care product comprising the unsubstituted crosslinked starch of any one of Aspects 1 to 23.

Aspect 74 is a paper product comprising the unsubstituted crosslinked starch of any one of Aspects 1 to 23.

Aspect 75 is the unsubstituted crosslinked starch of any one of Aspects 1 to 23 having a hot paste viscosity in a range of about 100 cP to about 1500 cP (measured at pH 3 and 5.5 wt-% solids), and a retrogradation enthalpy measured at 1 week of storage at 4° C. and a gelatinization enthalpy, wherein the retrogradation enthalpy is about 25% or less of the gelatinization enthalpy.

Aspect 76 is an unsubstituted crosslinked starch having a hot paste viscosity in a range of about 100 cP to about 1500 cP (measured at pH 3 and 5.5 wt-% solids), and a retrogradation enthalpy measured at 1 week of storage at 4° C. and a gelatinization enthalpy, wherein the retrogradation enthalpy is about 25% or less of the gelatinization enthalpy.

Aspect 77 is the unsubstituted crosslinked starch of Aspect 76 or 77, wherein the retrogradation enthalpy is about 20% or less, 15% or less, 10% or less, or 5% or less of the gelatinization enthalpy.

Aspect 78 is the unsubstituted crosslinked starch of any one of Aspects 1 to 23 or 75 to 77, wherein the retrogradation enthalpy, measured at 4 weeks of refrigerated storage, is about 60% or less, about 50% or less, or about 40% or less of the gelatinization enthalpy of the starch.

Aspect 79 is the unsubstituted crosslinked starch of any one of Aspects 1 to 23 or 75 to 78, wherein the retrogradation enthalpy, measured at 4 weeks of refrigerated storage, may be from 20% to 60%, 30% to 60%, 40% to 60%, or 50% to 60% of the gelatinization enthalpy of the starch.

### EXAMPLES

### Example 1

The gelatinization and retrogradation behavior of various starch samples was tested. In this study, starch retrogradation was characterized by differential scanning calorimetry (DSC). Since enthalpy (ΔH) reflects the melting of double helices, enthalpy of retrograded starches reflects the degree of retrogradation of starches. The samples were prepared by crosslinking a native starch with various amounts of sodium trimetaphosphate (STMP) or phosphorus oxychloride (POCl₃). Sample Preparation

Slurry preparation: An alkaline slurry of native starch was prepared. In a 5L plastic beaker, water, sodium hydroxide (NaOH), and sodium chloride (NaCl) were mixed using an overhead agitator. The amount of water was calculated to produce a 36 wt-% dry solids slurry with 1000 g of starch. The NaOH weight was 0.52 wt-% of the starch weight. Once the NaOH was dissolved, sodium chloride (NaCl) was added at 1.5 wt-% of the starch weight. 1000 g of native starch was then added to create a 36 wt-% dry solids slurry. The slurry was poured into a jacketed reactor with a water bath temperature set to 104° F. (40° C.) and agitated while heating.

STMP crosslinking: sodium trimetaphosphate (STMP) was added to the slurry once the temperature reached 105° F. (40.6° C.). The amount of STMP ranged from 0.1 wt-% to 0.35 wt-%. The reaction temperature was held for 8 h. The slurry pH was adjusted to 5.5 with dilute hydrochloric acid (HCl). The starch was dewatered through a Buchner funnel with Whatman #4 filter paper. After washing and dewatering, the starch was dried, crumpled and sieved.

POCl₃ crosslinking: phosphorus oxychloride (POCl₃) was added to the slurry dropwise with a pipette. The amount of POCl₃ ranged from 0.02 wt-% to 0.085 wt-%. The reaction temperature was held for 1 h. The slurry was drained into a beaker and the pH of the slurry was adjusted to 5.5 with dilute hydrochloric acid (HCl). The starch was dewatered through a Buchner funnel with Whatman #4 filter paper. After washing and dewatering, the starch was dried.

The viscosity of a sample was measured using a Rapid Visco Analyzer (RVA) model RVA 4800 from PerkinElmer Inc. in Waltham, MA. The samples were suspended in pH 3 buffer or pH 6.5 buffer at 5.5 wt-% sample content. The total suspension weighed 30.0 g. Each sample was then heated to 95° C. and held at this temperature for 20 minutes at a constant 160 RPM, while the viscosity of the sample was recorded.

Gelatinization parameters of starches were measured using a differential scanning calorimeter Q2000 from TA Instruments in New Castle, DE, equipped with a thermal analysis data station and data recording software (Universal Analysis 2000, also available from TA Instruments). Starch to water ratio was 1:3. Starch dispersions in water were equilibrated for 3 h at room temperature before DSC analysis. The scanning temperature range and the heating rates were 5-105° C. and 10° C./min, respectively. In all measurements, the thermogram was recorded with an empty aluminum pan as a reference. The transition temperatures reported are the onset (To), peak (Tp) and conclusion (Tc) temperatures. The enthalpy of gelatinization (ΔH) was estimated by integrating the area between the thermogram and a base line under the peak and was expressed as J/g of dry starch. The gelatinization parameters are shown in TABLE 2 below.

TABLE 2

| Crosslinked Waxy | Gelatinization Parameters | | | |
|---|---|---|---|---|
| tapioca starch | To (° C.) | Tp (° C.) | Tc (° C.) | ΔH (J/g) |
| 0.07% POCl₃ | 66.16 ± 0.16 | 70.08 ± 0.51 | 76.71 ± 0.15 | 14.18 ± 0.16 |
| 0.35% STMP | 65.67 ± 0.24 | 69.58 ± 0.33 | 76.40 ± 0.37 | 13.24 ± 0.34 |
| 0.04% POCl₃ | 65.32 ± 0.06 | 69.39 ± 0.20 | 76.42 ± 0,.04 | 13.45 ± 0.17 |
| 0.02% POCl₃ | 65.58 ± 0.34 | 69.74 ± 0.25 | 77.21. ± 0.16 | 13.51 ± 0.04 |
| 0.1% STMP | 65.74 ± 0.02 | 69.85 ± 0.04 | 76.76 ± 0.23 | 13.65 ± 0.43 |

Retrogradation parameters of the samples were measured using a TA Instruments, Q2000 differential scanning calorimeter equipped with a thermal analysis data station and data recording software (TA Instruments, Universal Analysis 2000). Starch to water ratio was 1:3 and the samples were scanned from 5 to 105° C. at 10° C./min. For all measurements, the thermogram was recorded with an empty pan as a reference. The gelatinized samples were cooled to room temperature (30 min) and then stored for 1, 2, 3, and 4 weeks at 4° C. and rescanned from 5° C. to 105° C. at 10° C./min. In all measurements, the thermogram was recorded with an empty aluminum pan as a reference. The transition temperatures reported are the onset (To), peak (Tp) and conclusion (Tc) temperatures. The enthalpy of gelatinization (ΔH) was estimated by integrating the area between the thermogram and a base line under the peak and was expressed as J/g of dry starch.

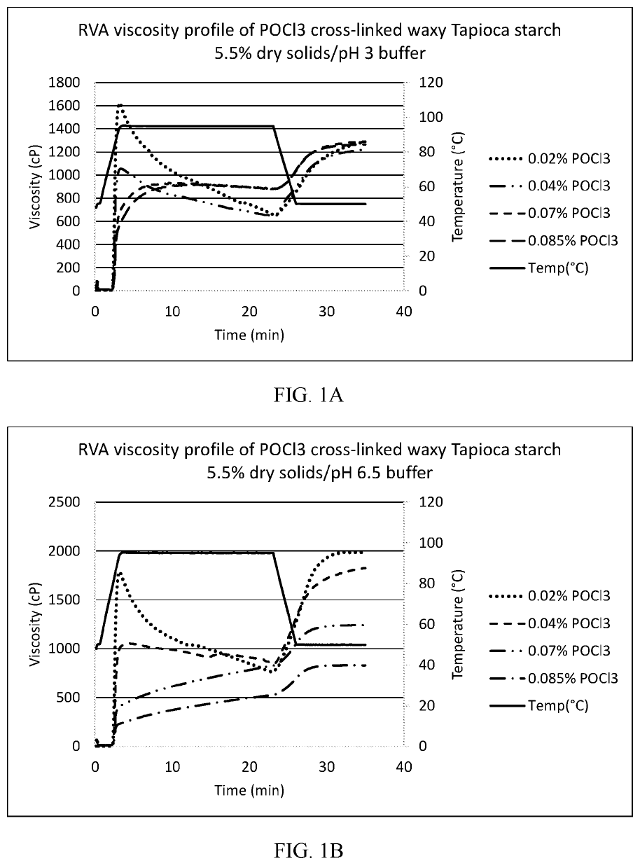

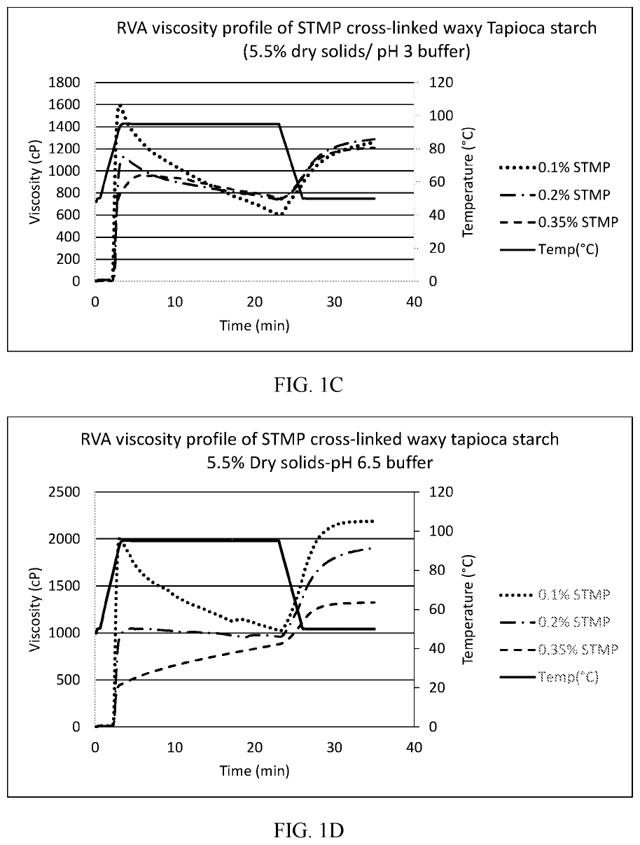

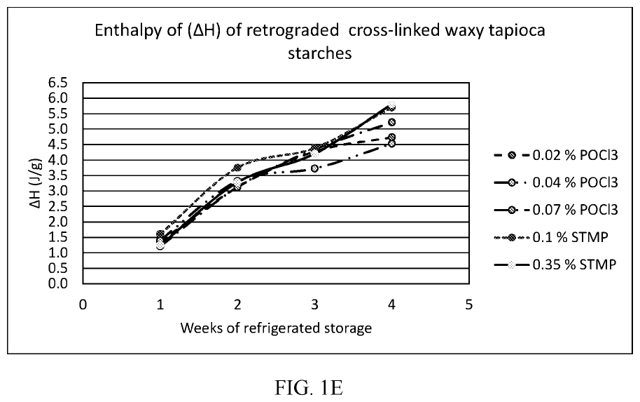

The RVA viscosity profiles of the samples are shown in FIG. 1A (POCl₃ crosslinked at pH 3), FIG. 1B (POCl₃ crosslinked at pH 6.5), FIG. 1C (STMP crosslinked at pH 3), FIG. 113 (STMP crosslinked at pH 6.5), and the DSC retrogradation enthalpy results are shown in FIG. 1E and in TABLE 3 below.

TABLE 3
Retrogradation Enthalpy

| | | | | | Conclusion temperature |
|---|---|---|---|---|---|
| Crosslinked waxy | Retrogradation Enthalpy (ΔH) J/g | | | | (Tc) of retrogradation |
| tapioca starch | Week 1 | Week 2 | Week 3 | Week 4 | Week 4 |
| 0.02% POCl3 | 1.36 ± 0.2 | 3.12 ± 0.0 | 4.28 ± 0.4 | 4.74 ± 0.1 | 64.73 ± 0.2 |
| 0.04% POCl3 | 1.12 ± 0.1 | 3.33 ± 0.4 | 3.73 ± 0.1 | 4.53 ± 0.3 | 65.12 ± 0.5 |
| 0.07% POCl3 | 1.21 ± 0.3 | 3.13 ± 0.6 | 4.35 ± 0.2 | 5.22 ± 0.1 | 64.55 ± 0.3 |
| 0.1% STMP | 1.61 ± 0.2 | 3.76 ± 0.1 | 4.39 ± 0.1 | 5.36 ± 0.1 | 65.48 ± 0.1 |
| 0.35% STMP | 1.25 ± 0.2 | 3.28 ± 0.1 | 4.21 ± 0.0 | 5.43 ± 0.0 | 64.93 ± 0.2 |

The hot paste viscosity results are shown in TABLE 4. The hot paste viscosity is the viscosity of the sample at the end of the holding time at 95° C.

TABLE 4
Hot paste viscosity of unsubstituted
cross-linked waxy tapioca starch

| | Crosslinking agent | Hot Paste |
|---|---|---|
| Sample ID | and amount | Viscosity |
| Sample 1 | POCl₃ 0.07% | 884 cP |
| Sample 2 | STMP 0.35% | 817 cP |
| Sample 3 | POCl₃ 0.085% | 877 cP |
| Sample 4 | POCl₃ 0.04% | 762 cP |
| Sample 5 | STMP 0.20% | 850 cP |
| Sample 6 | POCl₃ 0.02% | 813 cP |
| Sample 7 | STMP 0.10% | 747 cP |

### Example 2

The starch samples prepared in Example 1 were used to prepare various food samples including the starches. The foods included yogurt (samples 3A, 3B, and 3C), a creamy dessert (samples 4A, 4B, 4C, and 4D), a bakery filling (samples 5A and 5B), a fruit preparation (samples 6A, 6B, 6C, and 6D), a bechamel sauce (samples 7A and 7B), and a pizza sauce (samples 8A and 8B).

### Yogurt Samples (Samples 3A, 3B, and 3C):

The starches used in the yogurt samples 3A, 3B, and 3C were Sample 1 (0.07 wt-% POCh crosslinked); Sample 2 (0.35 wt-% STMP crosslinked); and Sample 3 (0.085 wt-% POCl₃ crosslinked), respectively. A comparative sample was prepared using commercially available crosslinked substituted waxy corn starch (hydroxypropyl distarch phosphate available as product number C*PolarTex 06739 from Cargill, Inc. in Wayzata, MN).

Milk (UHT with 1.5 wt-% fat) was mixed with 1.00 wt-% skimmed milk powder and 1.80 wt-% starch. The mixture was heated to 65° C., homogenized, and pasteurized at 95° C. for 5 min. The mixture was cooled to 43° C. and lactic cultures were mixed in. The mixture was fermented at 43° C. until the pH of the mixture reached 4.6. The finished product was stored at 4° C.

After 28 days of storage at 4° C., it was observed that the samples exhibited no syneresis or viscosity changes. The texture of samples 3A, 3B, and 3C was similar to the control.

### Creamy Dessert (Samples 4A, 4B, 4C, and 4D):

The starches used in the creamy dessert samples 4A, 4B, 4C, and 4D were Sample 1 (0.07 wt-% POCl₃ crosslinked); Sample 2 (0.35 wt-% STMP crosslinked); Sample 4 (0.04 wt-% POCl₃ crosslinked); and Sample 5 (0.2 wt-% STMP crosslinked), respectively. A comparative sample was prepared using commercially available crosslinked substituted waxy corn starch (hydroxypropyl distarch phosphate available as product number C*PolarTex 06741 from Cargill, Inc.).

Skim milk was mixed with 2.00 wt-% skimmed milk powder, 10.00 wt-% sucrose, 8.20 wt-% cream (35 wt-% fat content). 0.15 wt-% carrageenan, 2.00 wt-% starch, and 0.14 wt-% color and flavor (vanilla). The mixture was hydrated for 30 minutes and heated to 63° C. The mixture was sterilized at 135° C. for 15 s and pre-cooled to 70-75° C. The mixture was further cooled to 8-10° C.

After 28 days of storage at 4° C., it was observed that the samples exhibited no syneresis. The texture of samples 4A, 4B, 4C, and 4D was smooth and shiny and similar to the control. Creamy dessert samples with STMP crosslinked starch (samples 4B and 4D) showed enhanced creaminess in sensory testing compared to samples crosslinked with POCl₃ (samples 4A and 4C) or C*PolarTex 06741 (control).

### Fruit Preparation (Samples 5A, 5B, 5C, and 5D):

The starches used in the fruit preparation samples 5A, 5B, 5C, and 5D were Sample 1 (0.07 wt-% POCl₃ crosslinked); Sample 4 (0.04 wt-% POCl₃ crosslinked); Sample 5 (0.2 wt-% STMP crosslinked); and Sample 7 (0.1 wt-% STMP crosslinked), respectively. Comparative samples were prepared using commercially available crosslinked substituted waxy corn starches (hydroxypropyl distarch phosphate available as product number C*PolarTex 06741 and acetyl distarch adipate C*Tex 06214, both from Cargill, Inc.).

The starch (60 g) was pre-blended with 200 g sucrose and 1 g citric acid. Cold fruit (500 g strawberry pulp) was blended with 250 g cold water. The starch mixture was added to the fruit mixture, and the mixture was heated to 95° C. and maintained at 95° C. for 10 min. 0.5 g of potassium sorbate was added. The mixture was cooled to 35° C. and stored in the refrigerator.

After 3 months of storage at 4° C., it was observed that the samples exhibited no syneresis. The texture of samples 5A, 5B, 5C, and 5D was similar to the controls made with C*PolarTex 06741 and C*Tex 06214.

### Bechamel Sauce (Samples 6A and 6B):

The starches used in the yogurt samples 6A and 6B were Sample 6 (0.02 wt-% POCl₃ crosslinked); and Sample 7 (0.1 wt-% STMP crosslinked), respectively. A comparative sample was prepared using commercially available crosslinked substituted waxy corn starch (hydroxypropyl distarch phosphate available as product number C*PolarTex 06719 from Cargill, Inc.).

Dry ingredients including 9 g skimmed milk powder, 3.40-4.20 g starch, 1.00 g salt, and 0.50 g sodium caseinate were mixed. Water was added to the mixture. 7.50 g of butter was melted at 95° C. with mixing and the water mixture was added to the melted butter. The amount of water was calculated such that the total mixture was 100 g. The mixture was cooked at 95° C. for 10 min. The sample were filled into small pots and cooled in an ice bath.

The samples were exposed to 5 freeze-thaw cycles by freezing to −18° C. to −20° C. and defrosted overnight. After the 5 freeze-thaw cycles, it was observed that the samples exhibited no syneresis or gelling. The texture of samples 6A and 6B was similar to the control, exhibiting little graininess and a shiny surface.

### Pizza Sauce (Samples 7A and 7B):

The starches used in the pizza sauce samples 7A and 7B were Sample 4 (0.04 wt-% POCl₃ crosslinked); and Sample 5 (0.2 wt-% STMP crosslinked), respectively. A comparative sample was prepared using commercially available crosslinked substituted waxy corn starch (hydroxypropyl distarch phosphate available as product number C*PolarTex 06741 from Cargill, Inc.).

Wet ingredients including 20.00 wt-% tomato paste (28% brix), 3.00 wt-% sunflower oil, and water to bring the final mixture to 100 wt-%, were mixed in a mixer (IKA mixer with typhoon head). The wet mixture was transferred to Thermomix and stirred. Dry ingredients including 5 wt-% sugar, 2.60-2.70 wt-% starch, and 1 wt-% salt was added to the wet mixture and mixed. The mixture was heated to 95° C. with stirring and held at temperature for 10 min.

After 6 weeks of storage at 4° C., it was observed that the samples exhibited no syneresis. The texture of samples 7A and 7B was similar to the control.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A food product comprising:
an unsubstituted crosslinked starch having a hot paste viscosity in a range of about 100 cP to about 1500 cP (measured at pH 3 and 5.5 wt-% solids), and a retrogradation enthalpy measured at 1 week of storage at 4° C. and a gelatinization enthalpy, wherein the retrogradation enthalpy is about 25% or less of the gelatinization enthalpy, wherein when stored at 4° C. for at least 28 days the food product exhibits no syneresis.

2. The food product of claim 1, wherein the retrogradation enthalpy of the unsubstituted crosslinked starch measured at 1 week of storage at 4° C. is 2.3 J/g or less.

3. The food product of claim 1, wherein the unsubstituted crosslinked starch has a retrogradation enthalpy measured at 4 weeks of storage at 4° C. that is 50% or less of the gelatinization enthalpy.

4. The food product of claim 3, wherein the retrogradation enthalpy measured at 4 weeks of storage at 4° C. is 7 J/g or less.

5. The food product claim 1, wherein the unsubstituted crosslinked starch is prepared from waxy tapioca, waxy rice, waxy-sugary-2 corn mutant, short chain waxy potato, waxy wheat, high phosphorylated waxy starch, or a combination of any two or more thereof.

6. The food product of claim 1, wherein the unsubstituted, crosslinked starch is crosslinked using a crosslinking agent comprising sodium trimetaphosphate, phosphorus oxychloride, adipate, epichlorohydrin, citric acid or a combination of any two or more thereof.

7. The food product of claim 1, wherein the hot paste viscosity of the unsubstituted crosslinked starch is in a range of 400 cP to 1300 cP.

8. The food product of claim 1, wherein the retrogradation enthalpy of the unsubstituted crosslinked starch is 2.0 J/g or less at 1 week.

9. The food product of claim 1, wherein the unsubstituted crosslinked starch comprises 5 wt-% or less of amylose.

10. The food product of claim 1, wherein the unsubstituted crosslinked starch is not hydroxypropylated or acetylated.

11. The food product of claim 1, wherein the unsubstituted crosslinked starch is granular.

12. The food product of claim 1, wherein the unsubstituted crosslinked starch is stable through 4 or more freeze-thaw cycles.

13. (canceled)

14. (canceled)

15. The food product of claim 1, wherein the food product is a dairy product, a non-dairy yogurt or non-dairy pudding, a sauce, a gravy, a dressing, a dip, a spread, a bakery filling, a dry mix, a pet food, a retort food, or a canned pet food.

16. The food product of claim 1, wherein the unsubstituted, crosslinked starch makes up from about 1 wt-% to about 35 wt-% of the food product.

17.-20. (canceled)
